(19) United States
(12) Patent Application Publication
(10) Pub. No.: US 2021/0203745 A1
(43) Pub. Date: Jul. 1, 2021

(54) DATA TRANSMISSION METHOD AND SYSTEM

(71) Applicant: WANGSU SCIENCE & TECHNOLOGY CO., LTD., Shanghai (CN)

(72) Inventors: Xionglin CHEN, Shanghai (CN); Zhihui LAI, Shanghai (CN)

(21) Appl. No.: 16/078,170

(22) PCT Filed: Jul. 13, 2017
(86) PCT No.: PCT/CN2017/092752

§ 371 Date: Aug. 21, 2018

(30) Foreign Application Priority Data
Jul. 3, 2017 (CN) 201710532340.2

(51) Int. Cl. H04L 29/08; H04L 29/06

(52) U.S. Cl. CPC H04L 67/2885; H04L 65/4084; H04L 67/06; H04L 67/2871; H04L 67/288; H04L 67/2842

(57) ABSTRACT

The present disclosure provides a data transmission method and system. The method includes: requesting to access a data file from an intermediate node; receiving response data packets of the data file from the intermediate node, where the response data packets include a data file signature code uniquely identifying the data file; looking up the signature code in a signature code database; when the signature code is present in the signature code database, notifying the intermediate node to stop the transmission of the data file, and creating a cache pointer record to point to a cached data file corresponding to the signature code; and sending the cached data file to a user agent.

### FIELD OF THE DISCLOSURE

The present disclosure relates to the field of computer technologies and, more particularly, relates to a data transmission method and system, a computer storage medium, an edge node device, and an intermediate node device.

### BACKGROUND

Content delivery network (CDN) is built on the Internet, relies on edge servers deployed in various locations, and enables users to obtain desired contents from nearby servers through functional modules of a central platform such as load balancing, content distribution, and scheduling. Thus, the network congestion may be reduced, and the user access response speed and hit rate may be improved.

When an end user requests data from a CDN edge node, the CDN edge node may in turn request the same data from a CDN intermediate node. Currently, it is a common practice for the edge node to send the request to the intermediate node. The intermediate node returns all or a portion of data to the edge node. The edge node stores the data. When another user requests for the same data, the edge node may directly send the stored data to the user. However, under such circumstance, the existing method of data transmission between the edge node and the intermediate node includes the following disadvantages.

(1) For example, a file a.abc.com/a.avi and a file a.bcd.com/a.avi may be exactly the same file. However, a copy of each file may need to be cached in the edge node, which leads to the phenomenon of the storage resource being wasted in the edge node.

(2) Assuming that the file a.abc.com/a.avi is cached in the edge node, and the file a.bcd.com/a.avi is not cached in the edge node. When a user requests for the file a.bcd.com/a.avi, the edge node has to retrieve the file data from the intermediate node, which not only wastes time of data transmission, but also consumes bandwidth of data transmission.

Due to the existence of the above two disadvantages, the efficiency of data transmission is substantially low, which greatly impacts the user experience.

### BRIEF SUMMARY OF THE DISCLOSURE

To solve the problems in the existing technology, the present disclosure provides an edge node device and a data transmission method thereof, a computer storage medium and a communication device. The technical solutions are described below.

One aspect of the present disclosure provides a data transmission method. The method includes requesting to access a data file from an intermediate node; receiving response data packets of the data file from the intermediate node, wherein the response data packets include a signature code uniquely identifying the data file; looking up the signature code in a signature code database; when the signature code is present, notifying the intermediate node to stop the transmission of the data file, and creating a cache pointer record that points to a cache file to which the signature code corresponds; and sending the cache file to a user agent.

Further, the method also includes: when the signature code is absent, receiving and caching the data file transmitted from the intermediate node, recording the signature code in the signature code database, and sending the data file to the user agent.

Further, before a step of requesting to access the data file from the intermediate node, the method also includes: receiving a request to access the data file from the user agent; determining whether the data file is cached; when the data file is cached, sending the data file to the user agent; when the data file is not cached, determining whether a cache pointer record corresponding to the data file exists; when the cache pointer record is present, sending the cache file to which the cache pointer record points to the user agent; and when the cache pointer record is absent, requesting to access the data file from the intermediate node.

Further, the method also includes: initializing and calculating signature codes of all or a portion of cache files; and when signature codes of certain cache files are duplicated, preserving one copy of the cache files corresponding to the duplicated signature code, and creating cache pointer records that point to the preserved copy of the cache file for other cache files corresponding to the duplicated signature code.

Further, a step of initializing and calculating signature codes of all or a portion of cache files specifically includes: dividing the cache file into a plurality of segments according to a pre-determined segment length; calculating a hash value for each segment of the cache file, respectively; sequentially arranging a plurality of calculated hash values; and calculating another hash value for the plurality of sequentially arranged hash values to obtain a signature code of the cache file.

Another aspect of the present disclosure provides a data transmission method. The method includes: requesting to access a data file from an origin site; receiving and storing the data file transmitted from the origin site, and for the data file, calculating a signature code uniquely identifying the data file; looking up the signature code in a signature code database; when the signature code is present, creating a cache pointer record that points to a cache file to which the signature code corresponds; when the signature code is absent, recording the signature code in the signature code database; and adding the signature code to response data packets, and sending the signature code to an edge node along with the data file or the cache file to which the cache pointer record points.

Further, before a step of requesting to access the data file from the origin site, the method also includes: receiving a request to access the data file from the edge node; determining whether the data file is cached; when the data file is cached, adding the signature code uniquely identifying the data file to the response data packets, and sending the signature code to the edge node along with the data file; when the data file is not cached, determining whether a cache pointer record corresponding to the data file exists; when the cache pointer record is present, adding the signature code to the response data packets, and sending the signature code to the edge node along with the cache file to which the cache pointer record points; and when the cache pointer record is absent, requesting to access the data file from the origin site.

Further, the method also includes: initializing and calculating signature codes of all or a portion of cache files; and when signature codes of certain cache files are duplicated, preserving one copy of the cache files corresponding to the duplicated signature code, and creating cache pointer records that point to the preserved copy of the cache file for other cache files corresponding to the duplicated signature code.

Further, a step of, for the data file, calculating a signature code uniquely identifying the data file specifically includes: each time a segment of the data file having a pre-determined segment length is received, calculating a hash value for the segment of the data file; sequentially arranging a plurality of calculated hash values; and calculating another hash value for the plurality of sequentially arranged hash values to obtain a signature code of the data file.

Another aspect of the present disclosure provides a data transmission system. The data transmission system includes an edge node and an intermediate node that communicate with each other, where: the edge node is configured to receive a request to access a data file from a user agent and to request the data file from an intermediate node; and the intermediate node is configured to communicate with the edge node, receive the request from the edge node, and send response data packets to the edge node. The response data packets include a signature code uniquely identifying the data file. The edge node looks up the signature code in a signature code database. When the signature code is present, the edge node notifies the intermediate node to stop the transmission of the data file, creates a cache pointer record that points to a cache file to which the signature code corresponds, sends the cache file to the user agent.

Further, the edge node looks up the signature code in the signature code database. When the signature code is absent, the edge node receives and caches the data file transmitted from the intermediate node, records the signature code in the signature code database, and sends the data file to the user agent.

Further, the intermediate node receives the request from the edge node. The intermediate node determines whether the data file is cached. When the data file is cached, the intermediate node adds the signature code uniquely identifying the data file to the response data packets, and sends the signature code to the edge node along with the data file. When the data file is not cached, the intermediate node determines whether a cache pointer record corresponding to the data file exists. When the cache pointer record is present, the intermediate node adds the signature code to the response data packets, and sends the signature code to the edge node along with the cache file to which the cache pointer record points. When the cache pointer record is absent, the intermediate node requests to access the data file from the origin site.

Further, the intermediate node determines whether a cache pointer record corresponding to the data file exists, and when the cache pointer record is absent, the intermediate node requests to access the data file from the origin site. The intermediate node receives and stores the data file transmitted from the origin site and, for the data file, calculates a signature code uniquely identifying the data file. The intermediate node looks up the signature code in a signature code database. When the signature code is present, the intermediate node creates a cache pointer record that points to a cache file to which the signature code corresponds. When the signature code is absent, the intermediate node records the signature code in the signature code database. The intermediate node adds the signature code to the response data packets, and sends the signature code to the edge node along with the data file or the cache file to which the cache pointer record points.

Another aspect of the present disclosure provides a computer storage medium. The computer storage medium stores computer executable instructions. The computer executable instructions facilitate a computer to implement the disclosed data transmission method of the edge node.

Another aspect of the present disclosure provides an edge node device. The edge node device includes a memory configured to store program instructions, and a processor configured to retrieve the program instructions stored in the memory and execute the program instructions to implement the disclosed data transmission method of the edge node.

Another aspect of the present disclosure provides a computer storage medium. The computer storage medium stores computer executable instructions. The computer executable instructions facilitate a computer to implement the disclosed data transmission method of the intermediate node.

Another aspect of the present disclosure provides an intermediate node device. The intermediate node device includes a memory configured to store program instructions, and a processor configured to retrieve the program instructions stored in the memory and execute the program instructions to implement the disclosed data transmission method of the intermediate node.

The technical solutions provided by the present disclosure include the following beneficial effects. The edge node and/or the intermediate node uniquely identifies a data file using a signature code of the same. During the data transmission, the signature code in the response data packets is looked up and compared in the local signature code database to determine whether the requested data file matches any cache file to avoid duplicated transmission and duplicated storage of the data file that includes the same content as a cache file. Thus, the storage resource at the edge node and/or the intermediate node may be saved, and the network transmission bandwidth may be saved. When the signature code lookup finds a match, the data transmission speed may be substantially increased.

Moreover, the present disclosure fully utilizes the existing cache files at the edge node and/or the intermediate node. Only one copy of the duplicated cache files may be saved. A cache pointer record that points to the saved copy of the data file may be created for the other cache files corresponding to the same signature code. Thus, the storage resource at the edge node and/or the intermediate node may be further saved.

### BRIEF DESCRIPTION OF THE DRAWINGS

To more clearly illustrate the technical solutions of the present disclosure, the accompanying drawings to be used in the description of the disclosed embodiments are briefly described hereinafter. Obviously, the drawings described below are merely some embodiments of the present disclosure. Other drawings derived from such drawings may be obtained by a person having ordinary skill in the art without creative labor.

FIG. 1 illustrates a flow chart of an exemplary data transmission method of an edge node according to disclosed embodiments;

FIG. 2 illustrates an expanded flow chart of S11 shown in FIG. 1;

FIG. 3 illustrates a flow chart of an exemplary data transmission method of an intermediate node according to disclosed embodiments;

FIG. 4 illustrates a schematic diagram of an exemplary data transmission system according to disclosed embodiments;

FIG. 5 illustrates a schematic diagram of an exemplary edge node device according to disclosed embodiments; and

FIG. 6 illustrates a schematic diagram of an exemplary intermediate node device according to disclosed embodiments.

### DETAILED DESCRIPTION

To make the objectives, technical solutions, and advantages of the present disclosure clearer, the following further describes the embodiments of the present disclosure in details with reference to the accompanying drawings. It should be understood that the specific embodiments described herein are only used to explain the present disclosure and are not used to limit the present disclosure.

Detailed illustrations of a data transmission method according to embodiments of the present disclosure are provided hereinafter. The data transmission method may be applied to edge nodes of the CDN.

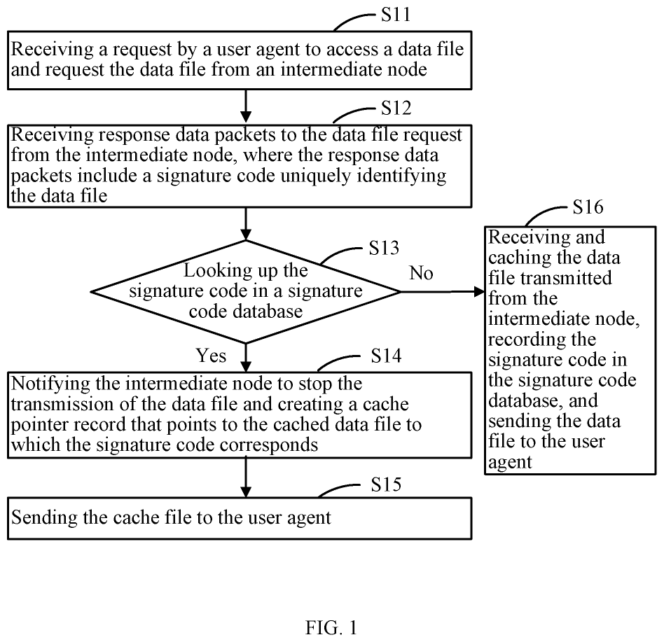

Referring to FIG. 1, FIG. 1 illustrates a flow chart of an exemplary data transmission method of an edge node according to disclosed embodiments.

In one embodiment, the data transmission method of an edge node may be applied to a content delivery network (CDN). The content delivery network may include an edge node and an intermediate node communicating with each other. Both the edge node and the intermediate node may be disposed between an end user and an origin site. The edge node may communicate with the end user, and the intermediate node may communicate with the origin site. Obviously, the edge node and the intermediate node may include various types of servers. For example, the edge node may include an edge server deployed on a user side, and the intermediate node may include an intermediate server deployed on a network side, which is not limited by the present disclosure.

At S11, a request by a user agent to access a data file is received, and the data file is requested from an intermediate node.

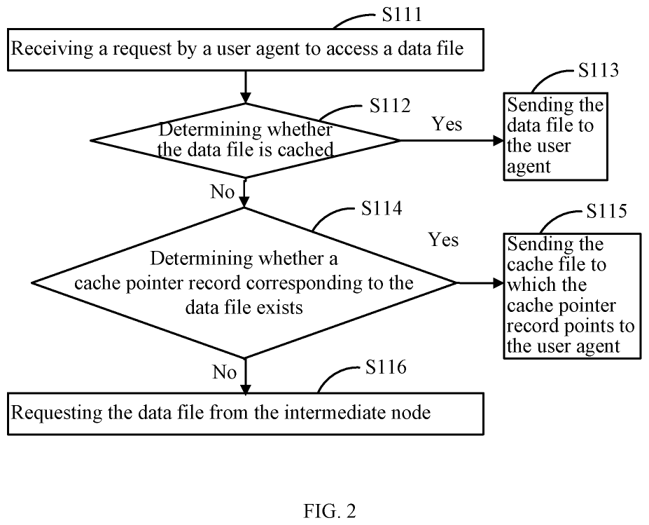

In one embodiment, the step S11 of receiving a request by a user agent to access a data file, and requesting the data file from an intermediate node may include six sub-steps S111-S116 as shown in FIG. 2.

Referring to FIG. 2, FIG. 2 illustrates an expanded flow chart of S11 shown in FIG. 1.

At S111, a request by a user agent to access a data file is received.

In one embodiment, for illustrative purposes, an end user may request to access a data file a.abc.com/a.avi. When the end user needs to access the data file a.abc.com/a.avi, the user agent may first send a request to access the data file a.abc.com/a.avi to the edge node.

At S112, whether the data file is cached is determined.

In one embodiment, after the edge node receives the user agent's request to access the data file a.abc.com/a.avi, the edge node may first determine whether the data file a.abc.com/a.avi is cached.

When it is determined that the data file is cached, at S113, the data file is sent to the user agent.

In one embodiment, when the data file a.abc.com/a.avi is cached, the edge node may directly send the cached data file a.abc.com/a.avi to the user agent.

When it is determined that the data file is not cached, at S114, whether a cache pointer record corresponding to the data file exists is determined.

In one embodiment, when the data file a.abc.com/a.avi is not cached, the edge node may further determine whether a cache pointer record corresponding to the data file a.abc.com/a.avi exists. In one embodiment, the data file a.abc.com/a.avi and the data file a.bcd.com/a.avi may include a completely same content while belonging to different domain names. For example, the data file a.abc.com/a.avi is a data file that the user agent requests from the domain name a.abc.com for the content a.avi, and the data file a.bcd.com/a.avi is a data file that the user agent requests from the domain name a.bcd.com for the same content a.avi. To avoid duplicated storages of the data files having the same content and to save storage resource, when storing in the local hard disk, the edge node may only store the data file a.bcd.com/a.avi as the complete data file and a cache pointer record, but may not store the actual data file a.abc.com/a.avi. The cache pointer record may point to the complete data file a.bcd.com/a.avi. When the data file a.abc.com/a.avi is searched, based on the cache pointer record, the data file a.bcd.com/a.avi may be automatically linked or directed to.

When it is determined that the cache pointer record is present, at S115, the cache file to which the cache pointer record points is sent to the user agent.

In one embodiment, when it is determined that the requested data file a.abc.com/a.avi is absent, but the cache pointer record corresponding to the data file a.abc.com/a.avi is present, it indicates that the edge node may store the cache file a.bcd.com/a.avi having the same content as the data file a.abc.com/a.avi. Based on the cache pointer record, the edge node may find the cache file a.bcd.com/a.avi, and may send the cache file a.bcd.com/a.avi to the user agent in response to the user agent's request to access the data file a.abc.com/a.avi.

When it is determined that the cache pointer record is absent, at S116, the data file is requested from the intermediate node.

When the edge node has neither the requested data file a.abc.com/a.avi nor the cache pointer record corresponding to the data file a.abc.com/a.avi, the edge node may send a request to access the data file a.abc.com/a.avi to the intermediate node with the expectation to obtain the user agent requested data file a.abc.com/a.avi from the intermediate node.

Referring to FIG. 1, at S12, response data packets to the data file request are received from the intermediate node, where the response data packets include a signature code uniquely identifying the data file.

In one embodiment, the edge node may receive the response data packets responding to the request of the data file a.abc.com/a.avi from the intermediate node. The response data packets may include a signature code to uniquely identify the data file a.abc.com/a.avi. To avoid affecting the transmission of the data file, the signature code may be included in the header of the first data packet of the response data packets. The data files having a same content may have a same signature code. For example, the data file a.abc.com/a.avi and the data file a.bcd.com/a.avi may have the same signature code. During the data transmission, the data file may be transmitted in segments. The first data packet that is transmitted first may already include the signature code. Based on the signature code obtained from the first data packet in the response data packets, the edge node may compare the signature code when other data packets of the data file have not been transmitted yet.

At S13, the signature code is looked up in a signature code database.

In one embodiment, the edge node may look up the signature code in a local signature code database.

Generally, when the edge node is not a brand new node, that is, the edge node has already stored certain cache files, it is necessary to calculate the signature codes for the already cache files and perform initialization operations, such that the signature codes may be used to uniquely identify the data files, and may be used in the subsequent signature code lookup and comparison. In one embodiment, the data transmission method of the edge node may further include the following steps.

The signature codes of all or a portion of the cache files may be initialized and calculated. When the signature codes of the cache files in the edge node are duplicated, only one copy of the cache files corresponding to the same signature code may be saved, and cache pointer records may be respectively created for the other cache files corresponding to the same signature code that points to the saved copy of the cache file. As such, the cache files actually having the same content may only occupy the memory space to store one copy of the cache files. The other cache files having the same content may be stored in the form of the cache pointer records, thereby substantially saving the memory space.

In one embodiment, the signature codes may be calculated using a segmented hash algorithm. For example, the process of calculating and initializing the signature codes of all or a portion of the cache files may include the following steps.

The cache file may be divided into a plurality of segments according to a pre-determined segment length. A hash value may be calculated for each segment of the cache file to obtain a plurality of hash values. The plurality of hash values may be sequentially arranged. Another hash calculation may be performed on the plurality of hash values to obtain the signature code of the cache file. The signature codes of all cache files may be stored in the local signature code database in the edge node. The cache files having a same content may be identified by a same signature code.

Referring to FIG. 1, when it is determined that the signature code is present, at S14, the intermediate node is notified to stop the transmission of the data file, and a cache pointer record is created that points to the cache file to which the signature code corresponds.

In one embodiment, regardless of the domain names to which the data files belong, the data files having a same content may be identified by a same signature code. When it is determined that the signature code is present, it indicates that the edge node may store the cache file a.bcd.com/a.avi that has the same content as the requested data file a.abc.com/a.avi. The edge node may notify the intermediate node to stop the transmission of the data file a.abc.com/a.avi, that is, the transmission of the response data packets is stopped and the connection between the edge node and the intermediate node is cut off, to avoid duplicated transmission of the data file, and to save the network bandwidth. A cache pointer record may be created that points to the cache file a.bcd.com/a.avi corresponding to the signature code. When another request to access the data file a.abc.com/a.avi is received, the cache file a.bcd.com/a.avi pointed by the cache pointer record may be used to respond to the user agent directly.

At S15, the cache file is sent to the user agent.

Because the requested data file a.abc.com/a.avi and the cache file a.bcd.com/a.avi cached in the edge node have the same content due to the same signature code, the edge node may send the locally stored cache file a.bcd.com/a.avi to the user agent in response to the user agent's request to access the data file a.abc.com/a.avi.

When it is determined that the signature code is absent, at S16, the data file transmitted from the intermediate node is received and cached. The signature code is recorded in the signature code database, and the data file is sent to the user agent.

In one embodiment, when it is determined that the signature code is absent, it indicates that the edge node may have to obtain and cache the data file a.abc.com/a.avi from the intermediate node. Thus, the edge node may receive and cache the data file a.abc.com/a.avi from the intermediate node, and may record the signature code included in the response data packets at S12 in the local signature code database to identify the data file a.abc.com/a.avi. The signature code may be used to compare with the signature code of the same data file in subsequent requests. The data file a.abc.com/a.avi obtained from the intermediate node may be sent to the user agent.

In the data transmission method provided by the present disclosure, signature codes are used to uniquely identify data files in the edge node. When the edge node is receiving the data transmitted from the intermediate node, the signature code included in the response data packets is looked up and compared in the local signature code database to determine whether the requested data file matches any cache file to avoid duplicated transmission and duplicated storage of the data file that includes the same content as a cache file. Thus, the storage resource at the edge node may be saved, and the network transmission bandwidth between the edge node and the intermediate node may be saved. When the signature code lookup finds a match, the edge node sends the cache file directly to the user agent as the user agent requested data file. The data file transmitted from the intermediate node is no longer needed to return to the user agent. Thus, the data transmission speed may be substantially increased.

Another data transmission method provided by the embodiments of the present disclosure is described below in details. The data transmission method is applicable to the intermediate node of the content delivery network.

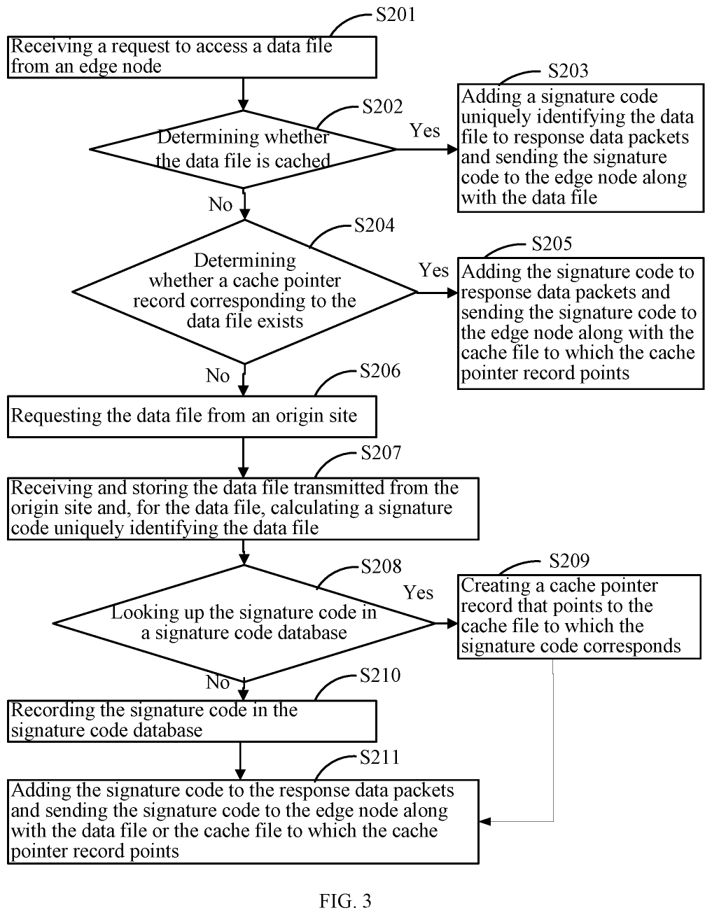

Referring to FIG. 3, FIG. 3 illustrates a flow chart of an exemplary data transmission method of an intermediate node according to disclosed embodiments.

At S201, a request to access a data file is received from an edge node.

In one embodiment, the intermediate node may receive a request to access a data file from an edge node. As can be seen at S116 shown in FIG. 2, when the edge node has neither the requested data file cached nor a corresponding cache pointer record, the edge node may send a request to the intermediate node with the expectation to obtain the user agent requested data file a.abc.com/a.avi from the intermediate node.

At S202, whether the data file is cached is determined.

In one embodiment, the intermediate node may determine whether the data file a.abc.com/a.avi is cached.

When it is determined that the data file is cached, at S203, a signature code uniquely identifying the data file is added to response data packets, and is sent to the edge node along with the data file.

For example, when it is determined that the data file a.abc.com/a.avi is cached, the intermediate node may add a signature code uniquely identifying the data file a.abc.com/a.avi to response data packets, and may send the signature code along with the data file a.abc.com/a.avi to the edge node. The signature code included in the response data packets may be used to determine whether the same signature code is present in the local signature code database in the edge node when the edge node is receiving the response data packets, that is, to determine whether the edge node already has a cache file having the same content as the data file received from the intermediate node.

When it is determined that the data file is not cached, at S204, whether a cache pointer record corresponding to the data file exists is determined.

In one embodiment, when it is determined that the data file is not cached, the intermediate node may determine whether a cache pointer record corresponding to the data file a.abc.com/a.avi exists. In one embodiment, the data file a.abc.com/a.avi and the data file a.bcd.com/a.avi may include the completely same content. When the intermediate node stores the data files in the local hard disk, the complete data file a.bcd.com/a.avi and only a cache pointer record corresponding to the data file a.abc.com/a.avi may be stored. The actual data file a.abc.com/a.avi may not be stored. The cache pointer record may point to the complete data file a.bcd.com/a.avi.

When it is determined that the cache pointer record is present, at S205, the signature code is added to response data packets, and is sent to the edge node along with the cache file to which the cache pointer record points.

In one embodiment, when it is determined that the cache pointer record is present, the intermediate node may find the cache file a.bcd.com/a.avi using the cache pointer record, and may add the signature code to the response data packets. The signature code may be included in the header of the first data packet in the response data packets, and may be sent to the edge node along with the cache file a.bcd.com/a.avi in response to the edge node's request to access the data file a.abc.com/a.avi.

When it is determined that the cache pointer record is absent, at S206, the intermediate node requests the data file from an origin site.

In one embodiment, when it is determined that the corresponding data file is not cached and the cache pointer record is absent, it indicates that the intermediate node may have to seek assistance from the origin site to obtain the data file a.abc.com/a.avi requested by the edge node from the origin site.

At S207, the data file transmitted from the origin site is received and stored, and a signature code uniquely identifying the data file is calculated for the data file.

In one embodiment, the intermediate node may receive and store the data file a.abc.com/a.avi transmitted from the origin site, and may calculate a signature code of the data file a.abc.com/a.avi that uniquely identifies the data file a.abc.com/a.avi. In one embodiment, a hash algorithm may be used to calculate the signature code that uniquely identifies the data file a.abc.com/a.avi. For example, when the intermediate node obtains the data file from the origin site, the data file may be transmitted in a plurality of segments or data packets. Each time a segment of the data file with a pre-determined length is received, the data file segment with the pre-determined length may be calculated to obtain a hash value. A plurality of hash values may be obtained until the complete data file is received. The plurality of hash values may be arranged sequentially. A hash value may be calculated from the plurality of hash values to obtain the signature code of the data file.

At S208, the signature code is looked up in a signature code database.

In one embodiment, the intermediate node may look up the signature code in the local signature code database.

Generally, when the intermediate node is not a brand new node, that is, the intermediate node has already stored cache files, it is necessary to calculate the signature codes for the already cache files and perform initialization operations, such that the signature codes may be used to uniquely identify the data files, and may be used in the subsequent signature code lookup and comparison. In one embodiment, the intermediate node data transmission method may include the following steps.

The signature codes of all or a portion of the cache files may be initialized and calculated. When the signature codes of the cache files in the intermediate node are duplicated, only one copy of the cache files corresponding to the same signature code may be saved, and cache pointer records may be receptively created for the other cache files corresponding to the same signature code that points to the saved copy of the cache file. As such, the actual cache files having the same content may only occupy the memory space to store one copy of the cache files. The other cache files having the same content may be stored in the form of the cache pointer records, thereby substantially saving the memory space.

When it is determined that the signature code is present, at S209, a cache pointer record that points to the cache file to which the signature code corresponds is created.

In one embodiment, when it is determined that the signature code is present, the intermediate node may create a cache pointer record that points to the cache file to which the signature code corresponds. When another request to access the data file a.abc.com/a.avi is received, the cache pointer record may be used to respond to the edge node directly with the cache file a.bcd.com/a.avi.

When it is determined that the signature code is absent, at S210, the signature code is recorded in the signature code database.

In one embodiment, when it is determined that the signature code is absent, the intermediate node may not have a cache file having the same content as the requested data file a.abc.com/a.avi. The signature code may be recorded in the local signature code database. When another request to access the data file a.abc.com/a.avi is received, the signature code may be looked up and compared.

At S211, the signature code is added to the response data packets, and is sent to the edge node along with the data file or the cache file to which the cache pointer record points.

In one embodiment, the intermediate node may add the signature code to the response data packets, and may send the signature code to the edge node along with the data file a.abc.com/a.avi or the cache file a.bcd.com/a.avi pointed by the cache pointer record.

In the data transmission method provided by the embodiments of the present disclosure, the intermediate node uniquely identifies a data file using a signature code of the same. When the intermediate node is receiving the data file transmitted from the origin site, the signature code is looked up and compared to determine whether the requested data file matches any cache file to avoid duplicated transmission and duplicated storage of the data file that includes the same content as a cache file. Thus, the storage resource at the intermediate node may be saved. Further, when the intermediate node sends the data file to the edge node, the signature code is added to the response data packets, such that the connected edge node looks up and compares the signature code in the local signature code database to determine whether any cache file has the same content. The method may avoid the duplicated transmission of the data file, and may save the network transmission bandwidth.

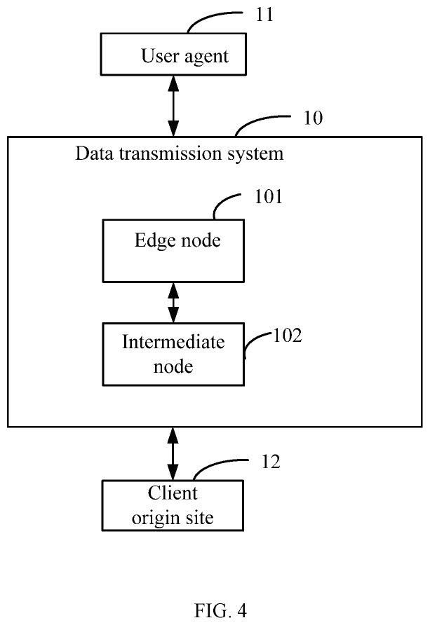

Referring to FIG. 4, FIG. 4 illustrates a schematic diagram of an exemplary data transmission system according to disclosed embodiments.

In one embodiment, as shown in FIG. 4, based on content delivery network, the data transmission system 10 may include an edge node 101 and an intermediate node 102 communicating with each other. The edge node 101 and the intermediate node 102 may be disposed between a user agent 11 and an origin site 12. The edge node 101 may communicate with the user agent 11. The intermediate node 102 may communicate with the origin site 12. Of course, the edge node 101 and the intermediate node 102 may include various types of servers. For example, the edge node 101 may include an edge server deployed on a user side, and the intermediate node 102 may include an intermediate server deployed on a network side, which is not limited by the present disclosure.

The edge node 101 may receive the request to access a data file from the user agent 11, and may request the data file from the intermediate node 102.

The intermediate node 102 may receive the request from the edge node 101, and may send the response data packets to the edge node 101. The response data packets may include a signature code uniquely identifying the data file.

The edge node 101 may look up the signature code in the signature code database. When the signature code is present, the edge node 101 may notify the intermediate node 102 to stop the transmission of the data file, create a cache pointer record that points to the data file corresponding to the signature code, and send the cache file to the user agent 11.

In one embodiment, the edge node 101 may look up the signature code in the signature code database. When the signature code is absent, the data file transmitted from the intermediate node 102 may be received and stored. The signature code may be recorded in the signature code database. The data file may be sent to the user agent 11.

In one embodiment, the intermediate node 102 may receive requests from the edge node 101.

In one embodiment, the intermediate node 102 may determine whether the data file is cached. When it is determined that the data file is cached, the signature code uniquely identifying the data file may be added to the response data packets, and may be sent to the edge node 101 along with the data file.

When it is determined that the data file is not cached, the intermediate node 102 may determine whether a cache pointer record corresponding to the data file exists. When it is determined that the cache pointer record is present, the cache file to which the cache pointer record points may be sent to the edge node 101. The signature code may be added to the response data packets, and may be sent to the edge node 101 along with the cache file.

In one embodiment, the intermediate node 102 may determine whether a cache pointer record corresponding to the data file exists. When it is determined that the cache pointer record is absent, the data file may be requested from the origin site 12.

In one embodiment, the intermediate node 102 may receive and store the data file transmitted from the origin site 12, and may calculate a signature code of the data file, which uniquely identifies the data file.

In one embodiment, the intermediate node 102 may look up the signature code in a signature code database. When the signature code is present, a cache pointer record may be created that points to the cache file to which the signature code corresponds. When the signature code is absent, the signature code may be recorded in the signature code database.

In one embodiment, the intermediate node 102 may add the signature code to the response data packets, and may send the signature code to the edge node 101 along with the data file or the cache file to which the cache pointer record points.

The process that the edge node 101 handles a request to access a data file may be the same as the process in the data transmission method of the edge node, and will not be repeated herein.

The process that the intermediate node 102 handles a request to access a data file may be the same as the process in the data transmission method of the intermediate node, and will not be repeated herein.

Moreover, the present disclosure also provides a computer storage medium. The computer storage medium may store computer executable instructions. The computer executable instructions may be used to implement the disclosed data transmission method of the edge node on a computer.

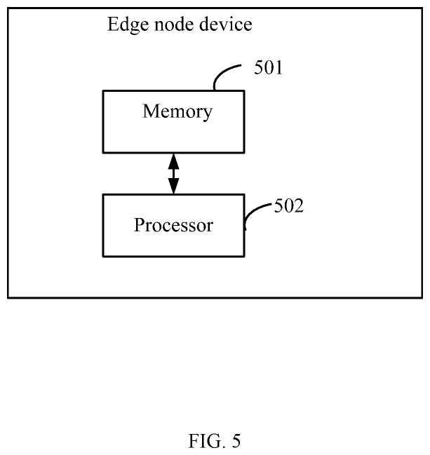

Referring to FIG. 5, FIG. 5 illustrates a schematic diagram of an exemplary edge node device according to disclosed embodiments. The edge node device may include a memory 501 configured to store program instructions and a processor 502 configured to retrieve the program instructions stored in the memory and to execute the retrieved program instructions to implement the disclosed data transmission method of the edge node.

Moreover, the present disclosure also provides a computer storage medium. The computer storage medium may store computer executable instructions. The computer executable instructions may be used to implement the disclosed data transmission method of the intermediate node on a computer.

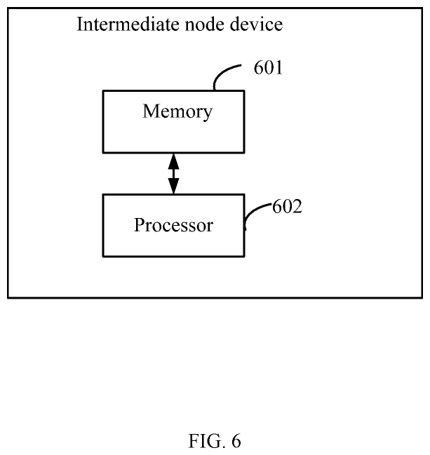

Referring to FIG. 6, FIG. 6 illustrates a schematic diagram of an exemplary intermediate node device according to disclosed embodiments. The intermediate node device may include a memory 601 configured to store program instructions and a processor 602 configured to retrieve the program instructions stored in the memory and to execute the retrieved program instructions to implement the disclosed data transmission method of the intermediate node.

The present disclosure provides the data transmission method and system, the computer storage medium, the edge node device, and the intermediate node device. The edge node and the intermediate node use the signature code to uniquely identify the data file and to avoid duplicated transmission and duplicated storage by applying the signature code comparison method. The highly efficient signature code transmission method substantially increases the speed of the data transmission, achieves sub-second instant transmission, causes substantially no interference to the existing data transmission and, at the same time, fully utilizes the existing cache files in the edge node. Thus, the storage resource at the edge node may be saved, and the network transmission bandwidth between the edge node and the intermediate node may be saved.

The system embodiments described above are merely for illustrative purpose. The units described as separated parts may or may not be physically detached. The parts displayed as units may or may not be physical units, i.e., may be located at one place, or distributed at a plurality of network units. Based on the actual needs, a part or all of the modules may be selected to achieve the objective of the embodiments. Those ordinarily skilled in the art may understand and implement the disclosed embodiments without contributing creative labor.

Through the descriptions of various aforementioned embodiments, those skilled in the art may clearly understand that the embodiments may be implemented by means of software in conjunction with an essential common hardware platform, or may be simply implemented by hardware. Based on such understanding, the essential part of the aforementioned technical solutions or the part that contribute to the prior art may be embodied in the form of software products. The software products may be stored in computer readable storage media, such as ROM/RAM, magnetic disk, and optical disk, etc., and may include a plurality of instructions to enable a computer device (may be a personal computer, a server, or a network device) to execute the methods described in various embodiments or parts of the embodiments.

The foregoing are merely certain preferred embodiments of the present disclosure, and are not intended to limit the present disclosure. Without departing from the spirit and principles of the present disclosure, any modifications, equivalent substitutions, and improvements, etc. shall fall within the scope of the present disclosure.

1. A data transmission method, comprising:
requesting to access a data file from an intermediate node;
receiving response data packets of the data file from the intermediate node, wherein the response data packets include a signature code uniquely identifying the data file;
looking up the signature code in a signature code database;
when the signature code is present, notifying the intermediate node to stop the transmission of the data file, and creating a cache pointer record that points to a cache file to which the signature code corresponds; and
sending the cache file to a user agent.

2. The method of claim 1, further including:
when the signature code is absent, receiving and caching the data file transmitted from the intermediate node, recording the signature code in the signature code database, and sending the data file to the user agent.

3. The method of claim 1, before a step of requesting to access the data file from the intermediate node, further including:
receiving a request to access the data file from the user agent;
determining whether the data file is cached;
when the data file is cached, sending the data file to the user agent;
when the data file is not cached, determining whether a cache pointer record corresponding to the data file exists;
when the cache pointer record is present, sending the cache file to which the cache pointer record points to the user agent; and
when the cache pointer record is absent, requesting to access the data file from the intermediate node.

4. The method of claim 1, further including:
initializing and calculating signature codes of all or a portion of cache files; and
when signature codes of certain cache files are duplicated, preserving one copy of the cache files corresponding to the duplicated signature code, and creating cache pointer records that point to the preserved copy of the cache file for other cache files corresponding to the duplicated signature code.

5. The method of claim 4, wherein a step of initializing and calculating signature codes of all or a portion of cache files specifically includes:
dividing the cache file into a plurality of segments according to a pre-determined segment length;
calculating a hash value for each segment of the cache file, respectively;
sequentially arranging a plurality of calculated hash values; and
calculating another hash value for the plurality of sequentially arranged hash values to obtain a signature code of the cache file.

6. A data transmission method, comprising:
requesting to access a data file from an origin site;
receiving and storing the data file transmitted from the origin site, and for the data file, calculating a signature code uniquely identifying the data file;
looking up the signature code in a signature code database;
when the signature code is present, creating a cache pointer record that points to a cache file to which the signature code corresponds;
when the signature code is absent, recording the signature code in the signature code database; and
adding the signature code to response data packets, and sending the signature code to an edge node along with the data file or the cache file to which the cache pointer record points.

7. The method of claim 6, before a step of requesting to access the data file from the origin site, further including:
receiving a request to access the data file from the edge node;
determining whether the data file is cached;
when the data file is cached, adding the signature code uniquely identifying the data file to the response data packets, and sending the signature code to the edge node along with the data file;
when the data file is not cached, determining whether a cache pointer record corresponding to the data file exists;
when the cache pointer record is present, adding the signature code to the response data packets, and sending the signature code to the edge node along with the cache file to which the cache pointer record points; and
when the cache pointer record is absent, requesting to access the data file from the origin site.

8. The method of claim 6, further including:
initializing and calculating signature codes of all or a portion of cache files; and
when signature codes of certain cache files are duplicated, preserving one copy of the cache files corresponding to the duplicated signature code, and creating cache pointer records that point to the preserved copy of the cache file for other cache files corresponding to the duplicated signature code.

9. The method of claim 6, wherein a step of, for the data file, calculating a signature code uniquely identifying the data file specifically includes:
each time a segment of the data file having a pre-determined segment length is received, calculating a hash value for the segment of the data file;
sequentially arranging a plurality of calculated hash values; and
calculating another hash value for the plurality of sequentially arranged hash values to obtain a signature code of the data file.

10. A data transmission system, comprising an edge node and an intermediate node communicating with each other, wherein:
the edge node is configured to receive a request to access a data file from a user agent and to request the data file from an intermediate node;
the intermediate node is configured to communicate with the edge node, receive the request from the edge node, and send response data packets to the edge node;
the response data packets include a signature code uniquely identifying the data file;
the edge node looks up the signature code in a signature code database; and
when the signature code is present, the edge node notifies the intermediate node to stop the transmission of the data file, creates a cache pointer record that points to a cache file to which the signature code corresponds, sends the cache file to the user agent.

11. The system of claim 10, wherein:
the edge node looks up the signature code in the signature code database; and
when the signature code is absent, the edge node receives and caches the data file transmitted from the intermediate node, records the signature code in the signature code database, and sends the data file to the user agent.

12. The system of claim 10, wherein:
the intermediate node receives the request from the edge node;
the intermediate node determines whether the data file is cached;
when the data file is cached, the intermediate node adds the signature code uniquely identifying the data file to the response data packets, and sends the signature code to the edge node along with the data file;
when the data file is not cached, the intermediate node determines whether a cache pointer record corresponding to the data file exists;
when the cache pointer record is present, the intermediate node adds the signature code to the response data packets, and sends the signature code to the edge node along with the cache file to which the cache pointer record points; and
when the cache pointer record is absent, the intermediate node requests to access the data file from the origin site.

13. The system of claim 12, wherein:
the intermediate node determines whether a cache pointer record corresponding to the data file exists, and when the cache pointer record is absent, the intermediate node requests to access the data file from the origin site;
the intermediate node receives and stores the data file transmitted from the origin site, and, for the data file, calculates a signature code uniquely identifying the data file;
the intermediate node looks up the signature code in a signature code database;
when the signature code is present, the intermediate node creates a cache pointer record that points to a cache file to which the signature code corresponds;
when the signature code is absent, the intermediate node records the signature code in the signature code database; and
the intermediate node adds the signature code to the response data packets, and sends the signature code to the edge node along with the data file or the cache file to which the cache pointer record points.

14.-17. (canceled)
